(19) United States
(12) Patent Application Publication
(10) Pub. No.: US 2012/0256356 A1
(43) Pub. Date: Oct. 11, 2012

(54) LAMINATED AND MOLDED BODY AND MANUFACTURING METHOD THEREFOR

(75) Inventors: Yoshio AKIYAMA, Tochigi-shi (JP); Shinichi ISHIYAMA, Tochigi-shi (JP)

(73) Assignee: YOSHINO KOGYOSHO CO., LTD., Tokyo (JP)

(21) Appl. No.: 13/529,884

(22) Filed: Jun. 21, 2012

Related U.S. Application Data
(62) Division of application No. 12/453,664, filed on May 18, 2009.
Application No. 12/453,664 is a continuation-in-part of application No. 12/379,097, filed on Feb. 12, 2009, now abandoned.
Application No. 12/379,097 is a continuation of application No. 11/597,380, filed on Jan. 4, 2007, now abandoned.
Application No. 12/453,664 is a continuation-in-part of application No. 10/522,744, filed on Aug. 17, 2005, now abandoned.

(30) Foreign Application Priority Data
Sep. 5, 2002 (JP) 2002-260083
May 31, 2004 (JP) 2004-161470

(51) Int. Cl. B29C 47/04; B29C 49/22

(52) U.S. Cl. 264/515; 264/209.1

(57) ABSTRACT

A laminated and molded body obtained by coextruding and molding at least two kinds of resin materials is preferable as a blow-molding aimed preform, a direct-blow molded bottle, a tube, or a blow molded tube, and has at least one layer constituted of a colored layer having a thickness continuously or intermittently varied in a direction parallel to the extruding direction of the at least one layer and/or in another direction intersecting the extruding direction, thereby enhancing the gradation effect.

This is a divisional application of prior pending application Ser. No. 12/453,664, filed May 18, 2009, which is a continuation-in-part of application Ser. No. 12/379,097, filed Feb. 12, 2009, which is a continuation of application Ser. No. 11/597,380, filed Jan. 4, 2007, which is a National Phase of International Patent Application No. PCT/JP05/09981, filed May 31, 2005; and a continuation in part of application Ser. No. 10/522,744filed Aug. 17, 2005, which is a National Phase of International Patent Application No. PCT/JP03/11321, filed Sep. 4, 2003. The disclosure of the prior applications is hereby incorporated by reference herein in its entirety.

### BACKGROUND

1. Technical Field

The present invention relates to a laminated and molded body such as a blow-molding aimed preform and a direct-blow molded bottle which are duly obtained by using a plurality of kinds of synthetic resins as materials and by coextruding them, and intends to bring about a variation of the color tone of the laminated and molded body to thereby further improve the aesthetic appearance thereof. The present invention further relates to a manufacturing method for manufacturing such a laminated and molded body.

2. Related Art

As containers made of synthetic resin for accommodating cosmetics or the like therein, there have been numerously used molded articles such as obtained by injection molding or blow molding synthetic resins, from a standpoint to attain a suitable mass-production and a reduced manufacturing cost. However, most of such molded articles are monotonous or have color tones of less variation, thereby resulting in a still insufficient aesthetic appearance of containers.

Thus, as described in JP-A-2000-117820, for example, it has been recently proposed to adopt such a technique to attain a variation of color deepness to be given to a container, for achieving a so-called gradation effect to thereby enhance the decorative effect of the container.

The technique described in the above publication is to previously provide a parison with a wall thickness difference at the time of injecting a translucent colored resin, and then blow molding the parison, to thereby cause the parison to have a partially different wall thickness. According to this technique, it has been believed to be able to attain a pattern based on a color deepness without requiring any specific process and able to restrict the manufacturing cost to a lower degree.

However, the above-mentioned related art still has problems which should be further improved, because the parison itself is provided with the wall thickness difference and thus the blow molded article also has the same wall thickness distribution as the parison, thereby complicating the wall thickness control upon blow molding, because those particularly thin portions of the container have a so lowered rigidity that the strength of the container is affected and that entrance of a gas (such as oxygen) from the exterior into the container becomes easy, thereby leading to an anxiety about a shortened quality assurance period for the contents accommodated within the container, because it is difficult to stably obtain molded articles having an excellent quality, and because the wall thickness of the dense color portion of the container is made to have a greater wall thickness than required to thereby lead to an increased cost when it is contemplated to preserve the rigidity of the whole container.

### SUMMARY

It is therefore an object of the present invention to propose a novel laminated and molded body and a manufacturing method therefor capable of solving the above-mentioned problems in the related art.

The present invention provides a laminated and molded body obtained by coextruding and molding at least two kinds of resin materials, wherein that at least one layer of the laminated and molded body comprises a colored layer having a thickness continuously or intermittently varied in a predetermined direction with respect to the extruding direction of the resin material of the colored layer (for example, in a direction parallel to the extruding direction and/or in another direction intersecting the extruding direction).

Further, the present invention provides a manufacturing method of a laminated and molded body to be formed by coextruding at least two kinds of resin materials, the method including extruding a colored layer as at least one layer of the laminated and molded body, and controlling an extruding amount of the resin material of the colored layer such that the colored layer has a thickness continuously or intermittently varied in a predetermined direction with respect to the extruding direction of the resin material of the colored layer (for example, in a direction parallel to the extruding direction and/or in another direction intersecting the extruding direction).

According to the present invention, it becomes possible to easily and assuredly obtain a laminated and molded body having an improved aesthetic appearance, by adjusting the supplying amount of the resin material forming the colored layer upon coextrusion. Further, the thickness of the resin material constituting the colored layer is continuously or intermittently varied along the predetermined direction, thereby allowing exhibiting such a visual effect, i.e., a so-called gradation effect that the color deepness of the colored layer is continuously or intermittently varied in the predetermined direction. For example, when the thickness of the resin material constituting the colored layer is varied in a direction parallel to the extruding direction, the color deepness of the colored layer is varied in the direction parallel to the extruding direction. Alternatively, when the thickness of the resin material constituting the colored layer is varied in a direction intersecting the extruding direction, the color deepness of the colored layer is varied in the direction intersecting the extruding direction.

It is desirable that the full thickness of the laminated and molded body is substantially uniform along the predetermined direction with respect to the extruding direction of the resin material, Namely, it is desirable to control an extruding amount of the resin material of at least one layer other than the colored layer, such that the full thickness of the laminated and molded body is substantially constant along the predetermined direction. In this case, the full thickness of the laminated and molded body is substantially uniform over the whole of the laminated and molded body even when the thickness of the colored layer is varied. Thus, there is never caused locally increased or decreased wall thickness, thereby enabling to obtain a molded article having a quality stabilized in terms of strength and to provide a laminated and molded body having an enhanced gradation effect with a restricted cost.

In the laminated and molded body having the above constitution, it is desirable that the colored layer has a thickness varied within a range of 50% of the full thickness of the laminated and molded body.

The laminated and molded body according to the present invention is advantageously applicable to a body portion of a container such as: a blow-molding aimed preform to be used upon biaxial-stretching blow molding; a direct-blow molded bottle or direct-blow molded tube to be obtained by direct-blow molding a coextruded parison; and a tube.

### BRIEF DESCRIPTION OF THE DRAWINGS

The present invention will be described hereinafter more in detail with reference to the embodiments shown in the accompanying drawings.

FIG. 1 is an explanatory constitutional view of a laminated and molded body according to an embodiment of the present invention;

FIG. 2 is an enlarged cross-sectional view of an essential part of the molded body shown in FIG. 1;

FIG. 3 though FIG. 13 are enlarged views of essential parts for explaining laminated structures in other embodiments of the present invention;

FIG. 14 is an explanatory constitutional view of a laminated and molded body according to a further embodiment of the present invention;

FIG. 15 is an enlarged cross-sectional view showing an essential part of the molded body shown in FIG. 14, in a developed state;

FIG. 16 is a planar development view along section B-B in of FIG. 14; and

FIG. 17 is an explanatory constitutional view of a laminated and molded body according to a still further embodiment of the present invention.

### DETAILED DESCRIPTION OF EMBODIMENTS

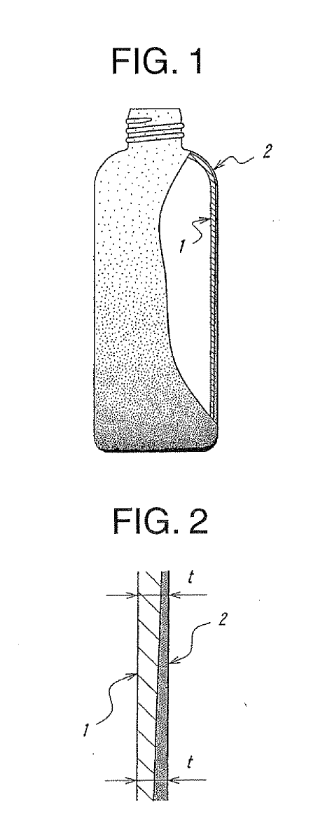

FIG. 1 exemplarily shows a blow molded article in a shape of dual-layered bottle-type container according to an embodiment of the present invention, wherein reference numeral 1 designates a main body portion as an inner layer, and reference numeral 2 designates a colored layer, alternatively referred to as an ornamental layer, arranged outside and integrally with the main body portion 1. The colored layer 2 has a thickness increased from a mouth portion of the molded article toward a bottom portion thereof, thereby gradually increasing the color density. Note, the main body portion 1 as the inner layer has a thickness reduced from the mouth portion of the molded article toward the bottom portion thereof, thereby achieving a substantially constant thickness “t” over the whole of the laminated and molded body.

The molded article shown in FIG. 1 is constituted as the container having an improved gradation effect provided by a color tone gradually deepened in a direction parallel to the extruding direction of the molded article, i.e., from, the mouth portion toward the bottom portion, thereby remarkably improving the aesthetic appearance of the container.

In molding such a container, it is possible to use a multi-layer coextrusion die of a type for simultaneously merging different resin materials or a type for sequentially merging them.

In this respect, it is possible to adjust the color deepness in a laminated and molded body, by appropriately controlling an extruding amount of a resin constituting the colored layer. Naturally, the thicker the colored layer, the deeper the color, and vice versa. In case of the container of FIG. 1 the essential part of which is enlargedly shown in FIG. 2, the colored layer 2 has a wall thickness distribution gradually reducing from the bottom portion toward the mouth portion, while the main body portion 1 as the inner layer has a wall thickness distribution gradually increasing from the bottom portion toward the mouth portion.

Upon coextrusion, the thickness of the colored layer 2 is appropriately varied by controlling the extruding amount of resin material, and the thickness of the main body portion 1 neighboring to the colored layer 2 is also varied correspondingly thereto. Thus, the full thickness of the laminated and molded body is kept substantially constant over the whole of the laminated and molded body, thereby never causing such portions having extremely reduced or increased thicknesses, except for wall thickness changes due to the product shape.

As materials for constituting the laminated and molded body, it is possible to use: an olefin-based resin such as polyethylene resin or polypropylene resin; and a polyester resin such as a polyethylene terephthalate resin (PET); and it is possible to use an ethylene vinyl alcohol copolymer (EVOH), nylon or the like, as a barrier resin.

The laminated and molded body having the above structure can be molded, by adopting a molding apparatus having a flow passage for supplying a resin material corresponding to the main body portion 1 as the inner layer and another flow passage for supplying a resin material corresponding to the colored layer 2 arranged outside and integrally with the main body portion 1, and by coextruding these resin materials.

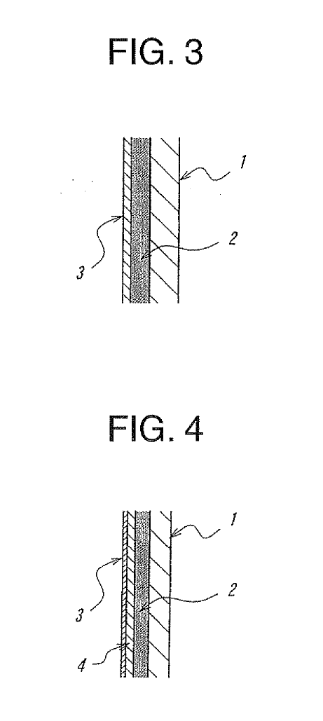

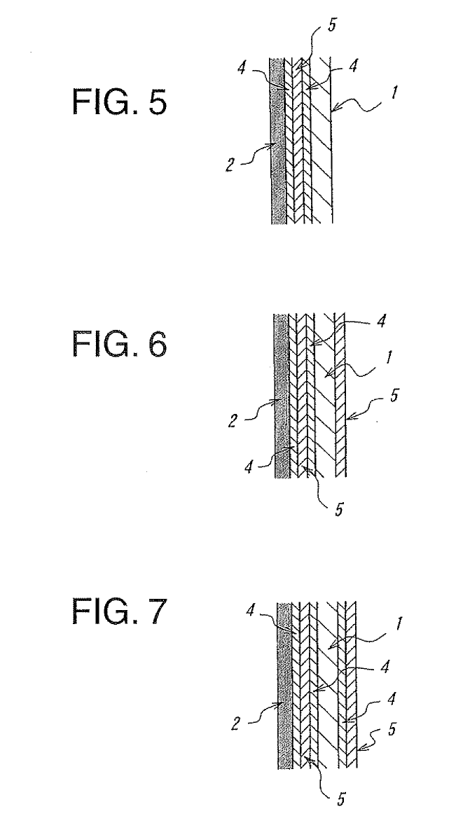

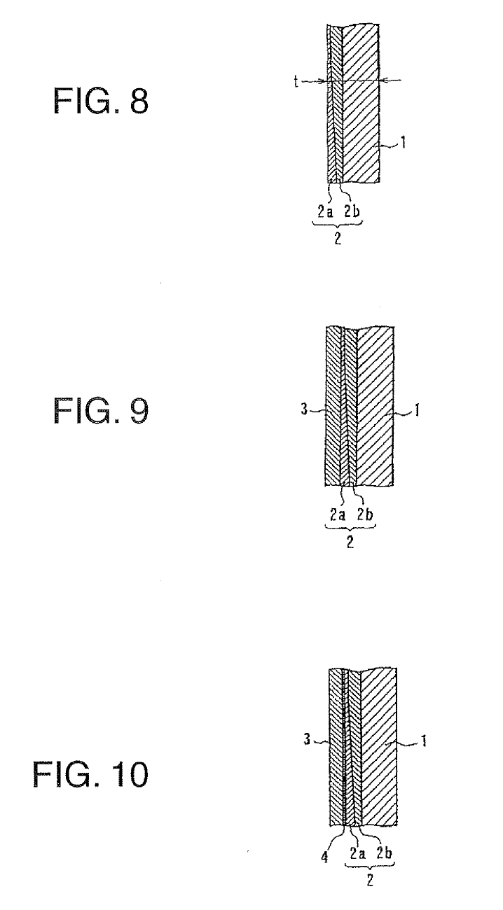

There will be explained hereinafter laminated and molded bodies according to the other embodiments shown in FIG. 3 through FIG. 7.

As shown in FIG. 3, the laminated and molded body according to another embodiment of the present invention is allowed to be provided with a frosting layer 3, alternatively referred to as a surface layer, comprising a glossy material or frosted material outside the colored layer 2, thereby making it possible to provide variations of not only a color deepness but also a color tone.

Further, as exemplarily shown in FIG. 4 through FIG. 7, each of the laminated and molded bodies according to the present invention can be provided as an appropriate combination of: an adhesive layer; and a barrier layer such as comprising EVOH or comprising meta-xylylene-group containing polyamide, for restricting permeation of oxygen. Namely, in a further embodiment of FIG. 4, there is arranged an adhesive layer 4 between the colored layer 2 and frosting layer 3 in the embodiment of FIG. 3. In a still another embodiment of FIG. 5, there are successively arranged an adhesive layer 4, a barrier layer 5 and another adhesive layer 4, between the main body portion 1 as an inner layer and the colored layer 2 in the embodiments of FIG. 1 and FIG. 2. In a still further embodiment of FIG. 6, there is arranged another barrier layer 5 also inside the main body portion 1 as an inner layer in the embodiment of FIG. 5. Further, in yet another embodiment of FIG. 7, there is also arranged another adhesive layer 4 between the main body portion 1 and the barrier layer 5 inside it in the embodiment of FIG. 6. Moreover, it is also possible to provide a layer including a known oxygen absorbent. Depending on the usage, the constitution of the layers can be appropriately modified in a manner different from the above, and no limitations are particularly imposed in this respect.

It is desirable that the thickness of the colored layer is varied within a range of 50% of the full thickness of the laminated and molded body. The reason therefor is the wall thickness variability and the external appearance of the colored layer. In addition to the provision of the gradation effect for the molded body based on the wall thickness variation of the colored layer, it is also possible to constitute the molded body by also providing the main body portion with another gradation effect.

As shown in FIG. 8, the color layer 2, alternatively referred to as the ornament layer, may be comprised of a colored film 2a made of a colored resin material, and a brightening layer 2b made of a resin material that brightens the colored film 2a, wherein the films 2a and 2b are laminated with each other. The colored film 2a has a transparency such that the film situated on the inner side is visible through the colored film. More concretely, the film situated on the outer side, i.e., the colored film 2a, is either made to have a reduced thickness, or made of a transparent or semi-transparent, colored resin material. In particular, if the colored film 2a is made to have a reduced thickness, it is preferred for the thickness to be within a range of 50% of the entire thickness of the laminated molded body as a whole. For example, if the total thickness “t” is 1.4 mm, the thickness of the colored film 2a is preferably not larger than 700 μm. By this, since the brightening film 2b situated on the inner side of the colored film 2a is visible through the colored film 2a, the colored film 2a is visible as being bright on the surface of the main body portion 1.

The material for the main body portion and the colored film 2a may be suitably selected from olefin-based resin such as polyethylene resin, polypropylene resin or the like; polyester resin such as polyethylene terephthalate resin (PET) or the like; and ethylene vinyl alcohol copolymer (EVOH), nylon or the like, as a barrier resin. As for the main body portion 1, in particular, there may be used a regenerated material originating from discarded materials obtained in other processes.

The material of the brightening film 2b may be suitably selected from a resin material containing a brightening agent, a resin material containing a pearl-like material reflecting light and exhibiting a pearly luster, and a resin material containing a powder material reflecting light and exhibiting a metallic luster, provided that it is a resin material capable of brightening the colored film. For example, if the brightening film 2b is comprised of a resin material containing a pearl-like material reflecting light and exhibiting a pearly luster, the pearl-like material may be a single color pearl material having a golden color, silver color or the like, a polarizing pearl having an iridescent color, mica, silica, etc. Further, if the brightening film 2b is comprised of a resin material containing a powder material reflecting light and exhibiting a metallic luster, the powder material may be a metal material such as fine aluminum or the like (including leaf or foil of gold), and silica or the like.

The laminated molded body of the structure described above can be molded by using a coextrusion die having a flow passage for supplying a resin material corresponding to the main body portion 1 as the inner layer, and flow passages for supplying resin materials corresponding, respectively, to the colored film 2a and brightening film 2b, which are arranged on the outer side of the main body portion 1, and by coextruding these resin materials. Upon coextrusion, as shown in FIG. 8, the extrusion volume of the resin materials is controlled so that the main body portion 1 has a thickness that is constant from the mouth portion to the bottom portion of the molded article, while the brightening film 2b has a thickness that decreases as the colored film 2a has a thickness that increases from the mouth portion to the bottom portion so that the laminated molded body as a whole has a total thickness “t” that increases toward the bottom portion. As a result, there is no extreme change in thickness except for local thickness variation due to the shape of the product.

The laminated molded body of the structure described above can be obtained easily and positively by controlling, upon coextrusion, the supply volume of the resin material forming the colored film 2a and the resin amount forming the brightening film 2b, as a product having an improved aesthetic appearance. With such a structure, it is possible to achieve such advantages, in addition to those of the case wherein ornament film or paintings are applied to obtain similar effects, as improved working efficiency due to reduced production steps, and cost reduction due to the reduced defects ratio or improved productivity.

In the embodiment, the thicknesses of the colored film 2a and the brightening film 2b, are continuously changed in a direction parallel to the extruding direction, so that the thickness of the colored film 2a increases from the mouth portion to the bottom portion of the molded article, while the thickness of the brightening film 2b decreases from the mouth portion to the bottom portion. In other words, the main body portion 1 as the inner layer has a thickness that is constant from the mouth portion to the bottom portion of the molded article, and the brightening film 2b has a thickness that decreases as the thickness of the colored film 2a increases, so that the laminated molded body has a substantially constant thickness as a whole. Thus, the colored film 2a has color shading that becomes progressively deep from the mouth portion to the bottom portion of the molded article, to exhibit a unique gradation effect wherein the color has such shading that it becomes progressively deep from the mouth portion to the bottom portion. Such an arrangement makes it possible to further improve the aesthetic appearance due to the gradation effect that brightens the color, and not only provides a wide variety of gradation effects, but also increases the variations in terms of color by combining selected colored film 2a and brightening film 2b out of various candidates.

Some variants of the laminated molded body will be described below with reference to FIGS. 9-13, wherein the basic structure shown in FIG. 8 is applied, respectively, to blow molded articles of four-layered structure, five-layered structure, seven-layered structure, eight-layered structure and nine-layered structure.

First of all, as shown in FIG. 9, a surface layer 3 comprised of a luster material or a defrosting material may be provided on the outer side of the ornament layer 2, so as to provide variation in color tone, in addition to the variation in color shading.

Furthermore, as exemplarily shown in FIGS. 10-13, various combinations are possible, which are provided with at least one adhesive layer 4 and at least one barrier layer 5 for suppressing transmission of oxygen, and comprised of EVOH, polyamide containing meta-xylylene group, or the like. In the variant shown in FIG. 10, an adhesive layer 4 is arranged between the ornament layer 2 and the surface layer 3 according to the variant of FIG. 9. In the variant shown in FIG. 11, there are successively arranged an adhesive layer 4, a barrier layer 5 and another adhesive layer 4, between the main body portion 1 as an inner layer and the colored layer 2 in the embodiment of FIG. 8. In the variant shown in FIG. 12, there is arranged a further barrier layer 5 on the inner side of the main body portion 1 as the inner layer of the variant of FIG. 11. In the variant shown in FIG. 13, a further adhesive layer 4 is arranged between the main body portion 1 and the barrier layer 5 on its inner side. Moreover, other than the above-mentioned layers, it is also possible to provide a layer containing known oxygen absorbent. The constitution of the layers can be appropriately modified depending upon usage, and the present invention is not particularly limited in this respect.

It is preferred that the colored film 2a or brightening film 2b has a thickness change within a range of 50% of the total thickness of the laminated molded body, in view of the wall thickness variability and the appearance of the colored film 2a or brightening film 2b. It is possible to realize a wide variety of gradation effects by varying the thickness of the colored film. For example, there may be adopted an adjacent type laminated layer arrangement by forming the main body portion 1 also as a colored layer, and laminating such main body portion 1 with the primary colored layer 2, so as to enlarge the selection range in terms of the gradation effects exhibiting pearly luster or metallic luster.

In a laminated layer arrangement wherein the laminated molded body includes a plurality of ornament layers 2, it is possible to adopt, besides the adjacent type laminated layer arrangement, a separated type laminated layer arrangement wherein adhesive layer 4, or a barrier layer 5, or a surface layer 6 is arranged between the ornament layers 2, so as to enlarge the selection range in terms of the gradation effects exhibiting the desired type of luster.

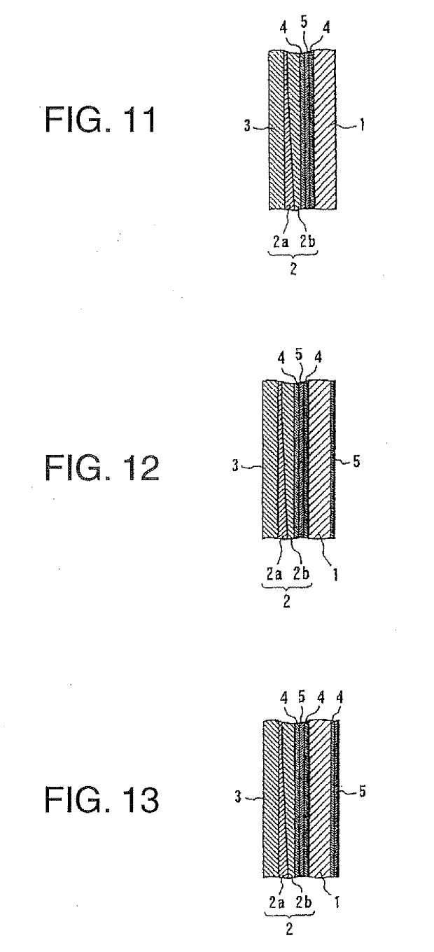

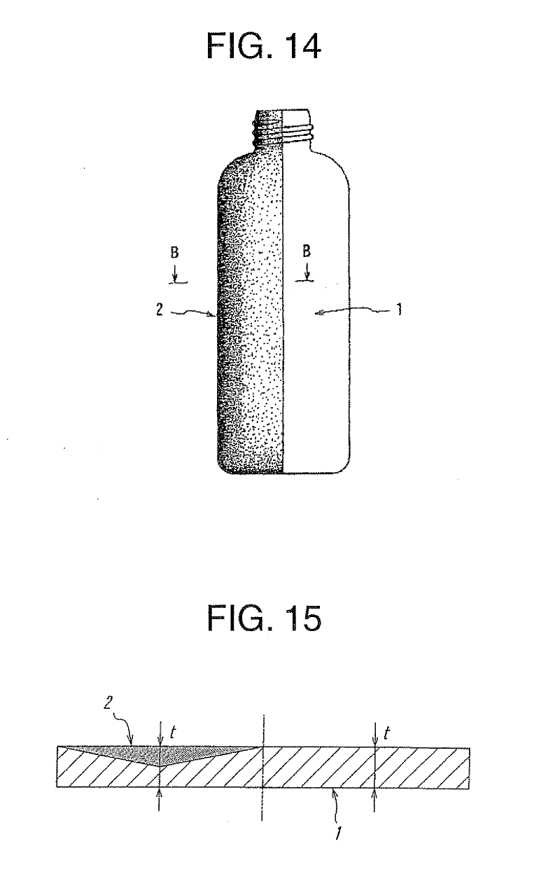

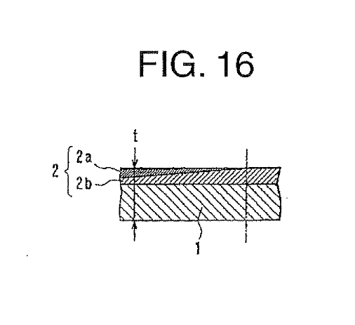

FIG. 14 and FIG. 15 exemplarily show a blow molded article in a shape of a dual-layered bottle-type container according to a yet further embodiment of the present invention, and FIG. 16 is a planar development view along the section B-B in FIG. 14, wherein the same reference numerals used in FIG. 1 and FIG. 2 are to denote identical or corresponding constituent elements.

In this embodiment, the main body portion 1 is provided with the colored layer 2 only over a half of a circumference of the main body portion 1 in its circumferential direction, and is not provided with the colored layer 2 over the remaining half of the circumference. The colored layer 2 is arranged outside and integrally with the main body portion 1. As shown in FIG. 9, the thickness of the colored layer 2 is gradually increased from its one end portion toward its central portion, and is gradually reduced from its central portion toward its other end portion. Thus, the colored layer 2 exhibits such a circumferential gradation effect that the color tone is deepened from the one end portion toward the central portion and is lightened from the central portion toward the other end portion.

Note, the laminated and molded body shown in FIG. 14 and FIG. 15 can be molded, such as by adopting a substantially crescent shape of a cross section of the flow passage at a portion for merging the resin material corresponding to the main body portion 1 as the inner layer with the resin material corresponding to the colored layer 2. Meanwhile, if there is provided appropriate controlling means for increasing/decreasing the sectional area of the flow passage at the merging portion in a timewise manner, it becomes possible to appropriately increase/decrease the thickness of the colored layer 2 not only in a direction intersecting the extruding direction but also in a direction parallel to the extruding direction, thereby making it possible to embody various gradation patterns.

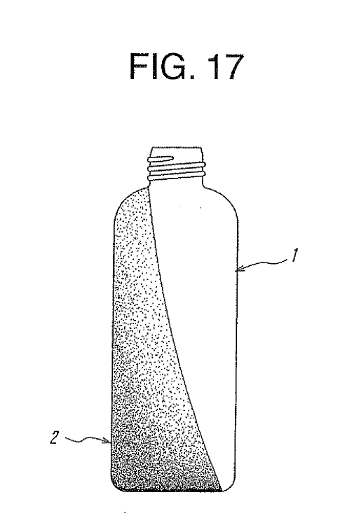

FIG. 17 shows another embodiment of the present invention in which the thickness of the colored layer 2 is increased and decreased in two directions consisting of a direction intersecting the extruding direction and another direction parallel to the extruding direction.

As apparent from the above and according to the present invention, it becomes possible to easily and assuredly obtain a laminated and molded body having an improved aesthetic appearance, only by adjusting the supplying amount of the resin material forming the colored layer upon coextrusion. Further, the full thickness “t” of the laminated and molded body is kept substantially constant over the whole of the laminated and molded body even when the thickness of the colored layer is varied. Thus, there is never caused locally increased or decreased wall thickness, thereby making it possible to obtain a molded article having a quality stabilized in terms of strength and to provide a laminated and molded body having an enhanced gradation effect with a restricted cost.

Although the present invention has been explained with reference to the preferred embodiments, it is apparent that the present invention can be performed in various configurations other than the above, without departing from the scope of the present invention.

Thus, for example, among the colored film 2a and the brightening film 2b, the colored film 2a is situated on the outer side in the embodiments described above. However, a modification may be made so as to arrange the brightening film 2b on the outer side, wherein the brightening film 2b has such a transparency as to allow the colored film 2a on the inner side to be visible therethrough, and a thickness that changes in continuous or stepless manner or stepwise manner.

The laminated molded body according to the present invention may be advantageously applied, not only to a blow molded preform for a biaxial-stretching blow molding process, or a bottle obtained by a direct blow molding process with respect to coextruded parisons, but also to a body portion of a container, such as a direct blow molded tube, a laminated tube or the like, and to covers for home electric appliances, such as television, personal computers or the like.

What is claimed is:

1. A manufacturing method of forming a laminated and molded body by coextruding at least two kinds of resin materials, said method comprising:
extruding a colored layer as at least one layer of said laminated and molded body from a first kind of resin material;
controlling an extruding amount of the resin material of said colored layer such that said colored layer has a thickness continuously varied in a predetermined direction with respect to the extruding direction of the resin material of said colored layer;
controlling an extruding amount of a second kind of resin material forming at least one layer other than said colored layer such that the full thickness of said laminated and molded body is substantially constant along said predetermined direction; and
controlling the extruding amount of the resin material of said colored layer such that said colored layer has a thickness varied within a range of 50% of the full thickness of said laminated and molded body.

2. The manufacturing method of claim 1, wherein:
the predetermined direction is a direction parallel to the extruding direction of said at least one layer of said laminated and molded body.

3. The manufacturing method of claim 1, wherein:
the predetermined direction is a direction intersecting the extruding direction of said at least one layer of said laminated and molded body.

4. The manufacturing method of claim 1, wherein:
the predetermined direction comprises a direction parallel to the extruding direction of said at least one layer of said laminated and molded body and another direction intersecting the extruding direction.

5. The manufacturing method of claim 1, wherein:
said laminated and molded body forms a blow-molding aimed preform, a direct-blow molded bottle, a tube, or a blow molded tube.
